(19) United States
(12) Patent Application Publication
(10) Pub. No.: US 2025/0088546 A1
(43) Pub. Date: Mar. 13, 2025

(54) CALL SERVICE INTEGRATION FOR INTERNET-OF-THINGS DEVICES

(71) Applicant: T-Mobile USA, Inc., Bellevue, WA (US)

(72) Inventors: Chakravarthi Japa, Frisco, TX (US); Mallika Deshpande, Bellevue, WA (US); Mark Allen, Renton, WA (US)

(21) Appl. No.: 18/464,154

(22) Filed: Sep. 8, 2023

(51) Int. Cl. H04L 65/1069; H04L 65/1016; H04L 65/1104

(52) U.S. Cl. CPC H04L 65/1069; H04L 65/1016; H04L 65/1104; H04W 80/10; H04W 88/16

(57) ABSTRACT

Techniques related to integrating carrier-grade call services to Internet-of-Things (IoT) devices are disclosed. In one example aspect, a system configured to integrate a call service to an IoT device of a user includes a call service network in a core network, a gateway server in communication with the IoT device and the call service network, and a communication plugin. The gateway server is configured to facilitate an exchange of one or more call signaling messages between the IoT device and the call service network. The communication plugin is deployed on a mobile device of the user to direct a service integration request from the user to the call service network to enable integration of an IoT service account of the user and a call service account of the user.

### BACKGROUND

The Internet-of-Things (IoT) describes devices with sensors, processing ability, software, and other technologies that connect and exchange data with other devices and systems over the Internet or other communications networks. With the development of conversational artificial intelligence, voice-enabled technology from virtual assistants to interactive streaming ads, enables a series of connected systems that speak, listen, and interact with users through simple conversations.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 illustrates an example service integration configuration in accordance with one or more embodiments of the present technology.

FIG. 4A illustrates an example user interface in accordance with one or more embodiments of the present technology.

FIG. 4B illustrates another example user interface in accordance with one or more embodiments of the present technology.

FIG. 4C illustrates another example user interface in accordance with one or more embodiments of the present technology.

FIG. 4D illustrates yet example user interface in accordance with one or more embodiments of the present technology.

FIG. 5 illustrates an example configuration of a cloud service interface that enables account linking in accordance with one or more embodiments of the present technology.

FIG. 6A is a sequence diagram illustrating an example flow of an account integration procedure in accordance with one or more embodiments of the present technology.

FIG. 6B is another sequence diagram illustrating an example flow of an account integration procedure in accordance with one or more embodiments of the present technology.

FIG. 7A illustrates an example sequence flow of initiating an outbound call from an IoT device in accordance with one or more embodiments of the present technology.

FIG. 7B illustrates an example sequence flow of an outbound emergency call from an IoT device in accordance with one or more embodiments of the present technology.

FIG. 7C illustrates an example sequence flow of an inbound call from an IoT device in accordance with one or more embodiments of the present technology.

FIG. 8 illustrates an example emergency call configuration in the call service provider's network in accordance with one or more embodiments of the present technology.

FIG. 9 is a flowchart representation of a method for enabling a call service on an Internet-of-Things (IoT) device of a user in accordance with one or more embodiments of the present technology.

FIG. 10 is a block diagram that illustrates an example of a computer system in which at least some operations described herein can be implemented.

The technologies described herein will become more apparent to those skilled in the art by studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Internet-of-Things (IoT) is a term that refers to objects that are connected to the Internet. Advances in technologies such as sensors, cloud computing, and wireless communications enable a wide variety of IoT devices, ranging from household appliances, automobiles, to industrial tools. Furthermore, with the rise of artificial intelligence, voice-enabled devices that are configured to speak and listen can allow humans and machines to interact through a simple conversation. For example, voice-enabled smart home devices such as Amazon Echo, Google Home, and Apple HomePod/Siri are becoming prevalent in households. In 2021, approximately 31.2% of the U.S. population owned or operated voice-enabled smart devices. This number will continue to grow in the coming years with an estimated increase to over 33.37% in 2025.

When a user operates an IoT device, such as a voice-enabled smart home device or an IoT device deployed on a personal vehicle, it is desirable to integrate the IoT device with the call/call service so that the user can easily initiate calls using the IoT device without the need to access his or her cell phone(s). From the network operator's perspective, it is also desirable to provide a framework to enable easy integration of different types of IoT devices from different manufacturers. This patent document discloses techniques that can be implemented in various embodiments to enable users to make and receive calls on various types of IoT devices using their existing mobile numbers. Leveraging interfaces that can authorize/link user accounts and enable peer-to-peer communications between IoT devices and the backend call service network, the disclosed techniques can provide carrier-grade call service with emergency calling capabilities to voice-enabled IoT devices. The disclosed techniques can also be implemented to provide a framework to facilitate network operators to integrate their call service with various IoT systems/services.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

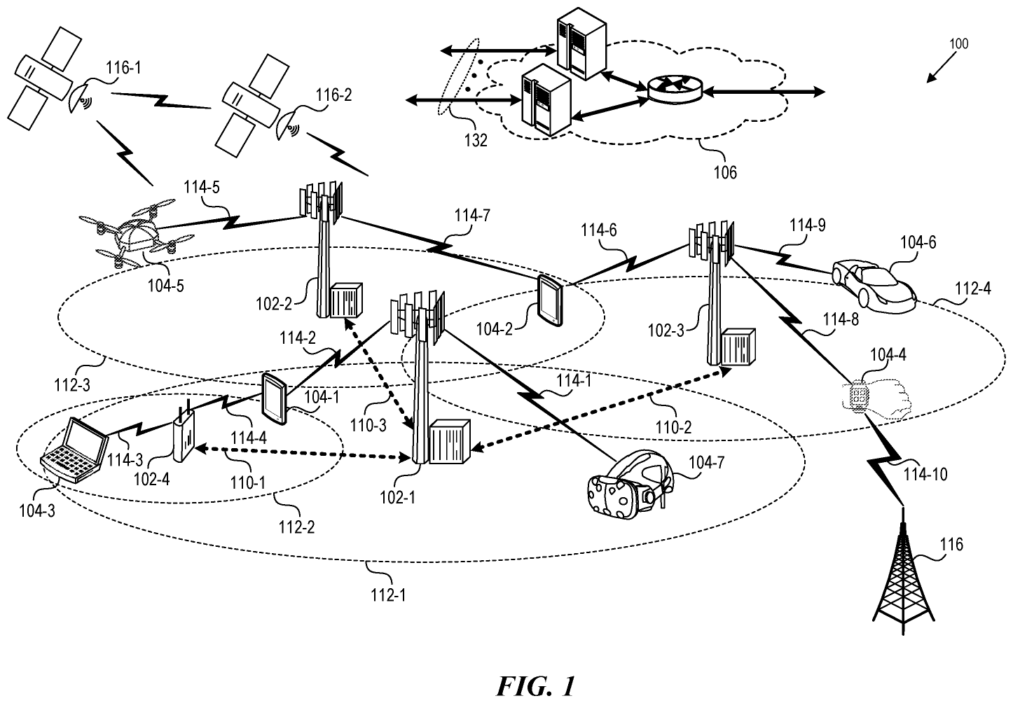

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet-of-Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally, or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QOS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

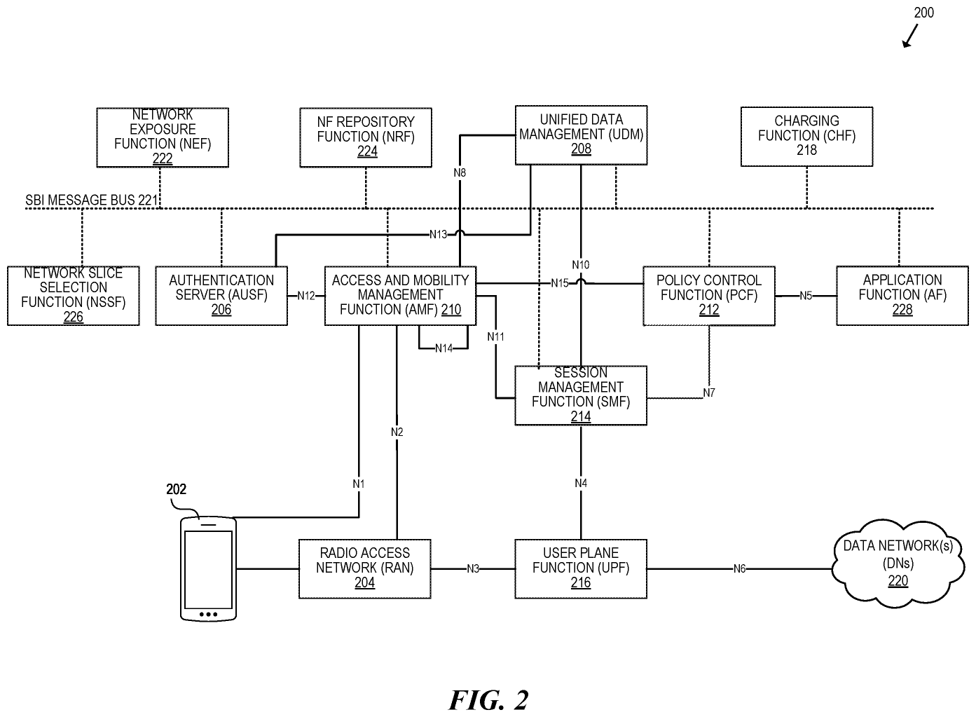

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Call Service Integration for Internet-of-Things Devices

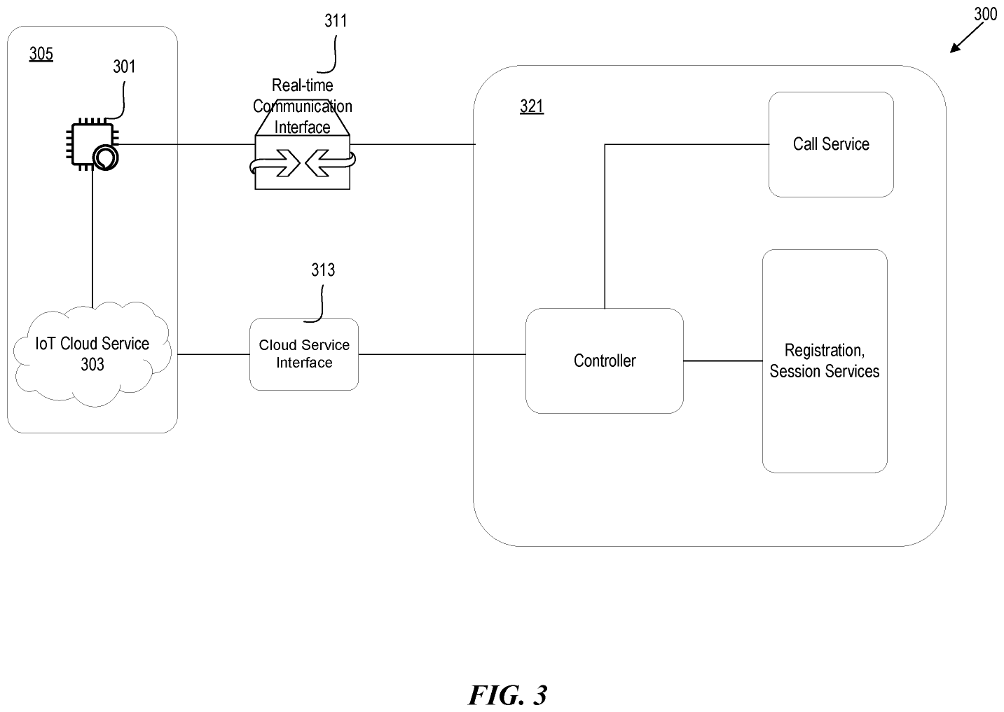

FIG. 3 illustrates an example service integration configuration in accordance with one or more embodiments of the present technology. The example configuration 300 includes two interfaces between the IoT system 305 and the network operator's backend call service network 321: a real-time or near real-time communication interface 311 to enable direct communication with the IoT device 301, and a cloud service interface 313 that is in communication with the IoT service 303. In some embodiments, the real-time or near real-time communication interface 311 can be implemented using Web Real-Time Communication (RTC) gateway. WebRTC allows audio and video communication by allowing direct peer-to-peer communication, eliminating the need to install plugins or download native apps. Alternative interfaces, such as Element or Autobahn, can also be used. In some embodiments, the cloud service interface 313 can be implemented as a software component that communicates with the IoT service 303 and the call service network 321 to ensure proper authentication and authorization of the IoT device for performing the call(s). For example, the cloud service interface can be implemented as a mobile application plugin or a part of the mobile application corresponding to the IoT device/service (e.g., Alex Skills, Google Home plugins) to facilitate communications between the IoT service and the call service network.

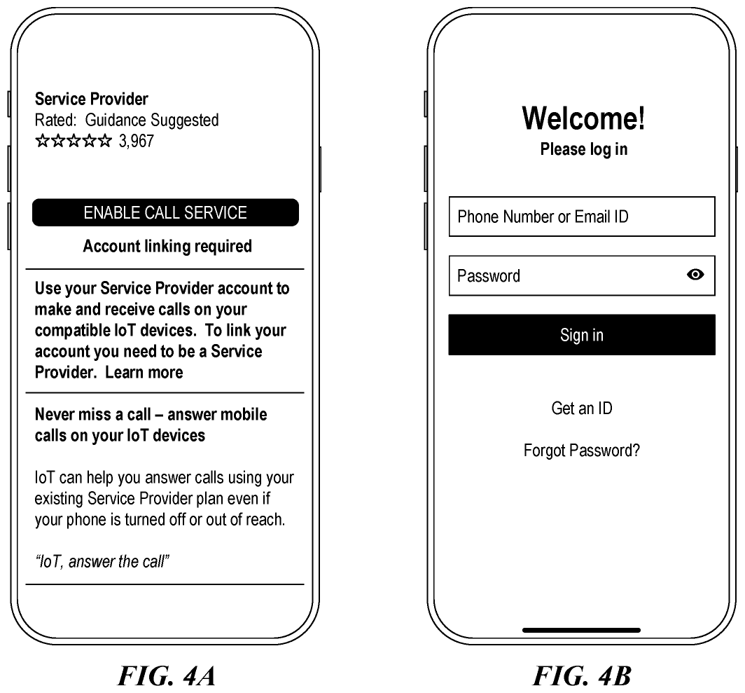

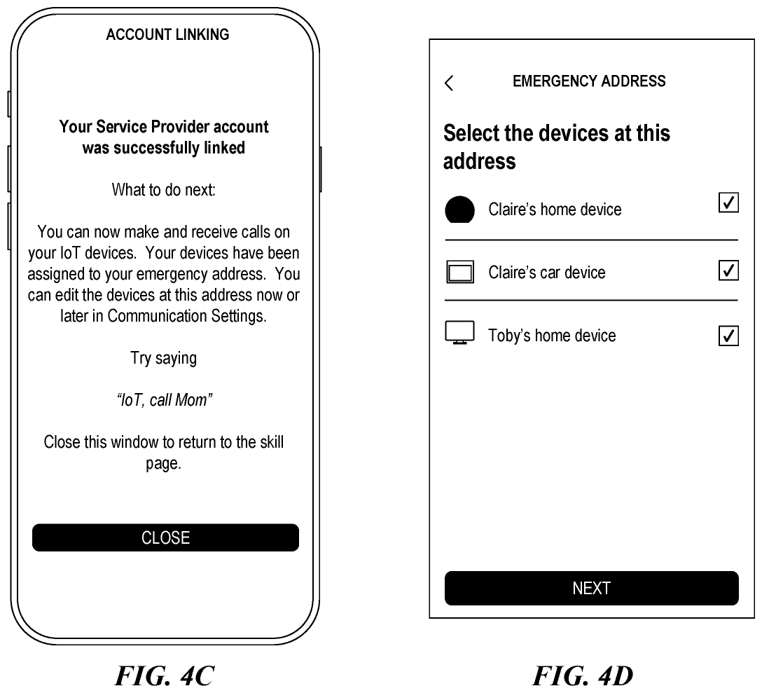

FIGS. 4A-D illustrate an example user interface to initiate an integration procedure in accordance with one or more embodiments of the present technology. As mentioned above, the cloud service interface 313 can be implemented as a mobile application plugin. In this example, a plugin is deployed as part of the mobile application corresponding to the IoT device. Via the user interface of the mobile application and the plugin, a user can enable calling functionality on IoT devices by sending a request to link the two accounts: the IoT service account and the call service account. As shown in FIG. 4A, the user can click on “enable calling” on the user interface of the plugin in the IoT mobile application. The user is then redirected to the login page of the call service provider, as shown in FIG. 4B. After the user enters the credentials, the user is provided with a confirmation that the accounts have been linked (shown in FIG. 4C). The user can then select/deselect devices to enable the calling functionality (shown in FIG. 4D).

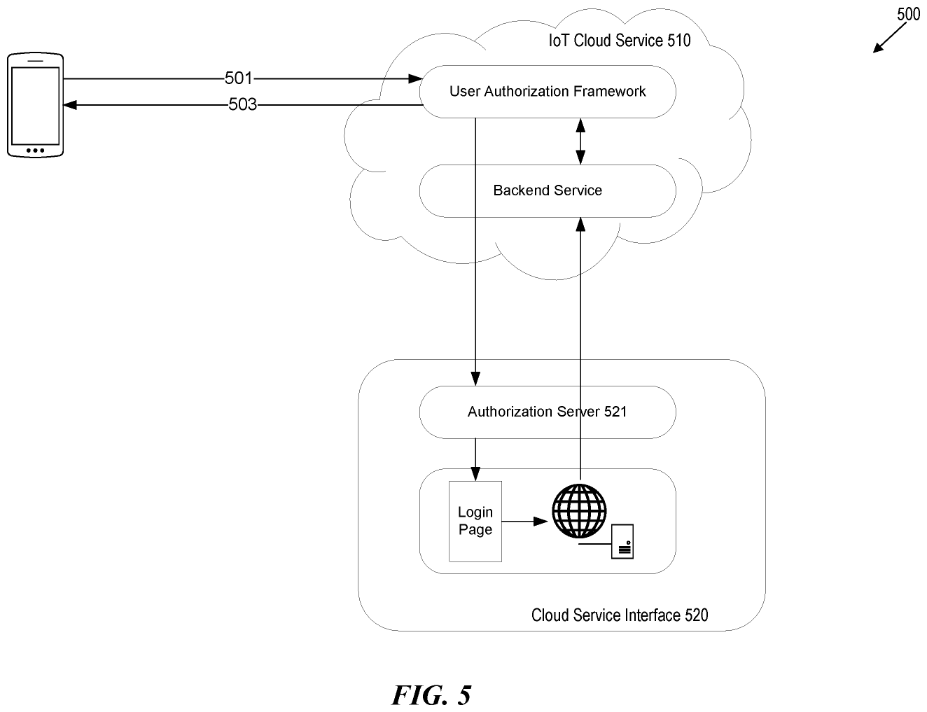

FIG. 5 illustrates an example configuration 500 of a cloud service interface that enables account linking in accordance with one or more embodiments of the present technology. As shown in FIG. 5, when the user initiates the account integration procedure (account linking), a request 501 is transmitted to the IoT service 510 to authorize the user. The IoT service 510 communicates with an authorization server 521 provided by the cloud service interface 520 (e.g., via the plugin deployed on the mobile device). The authorization server 521 can redirect the user to a login page so that the user can enter the user credential information used for the call service provider. After verifying the user credential information, a confirmation message can be communicated back to the IoT service 510 to complete the authorization as well as the linking procedure. The user then gets a confirmation 503 on the mobile device. Once the initial authorization flow completes, a user token can be exchanged between the IoT service 510 and cloud service interface 520 so that the user can continue with the integrated services without the need to re-enter credential information multiple times. In some embodiments, the authentication and authorization process can be implemented using an industry-standard protocol, such as OAuth 2.0 according to Internet Engineering Task Force (IETF) Request for Comments (RFC) 6749.

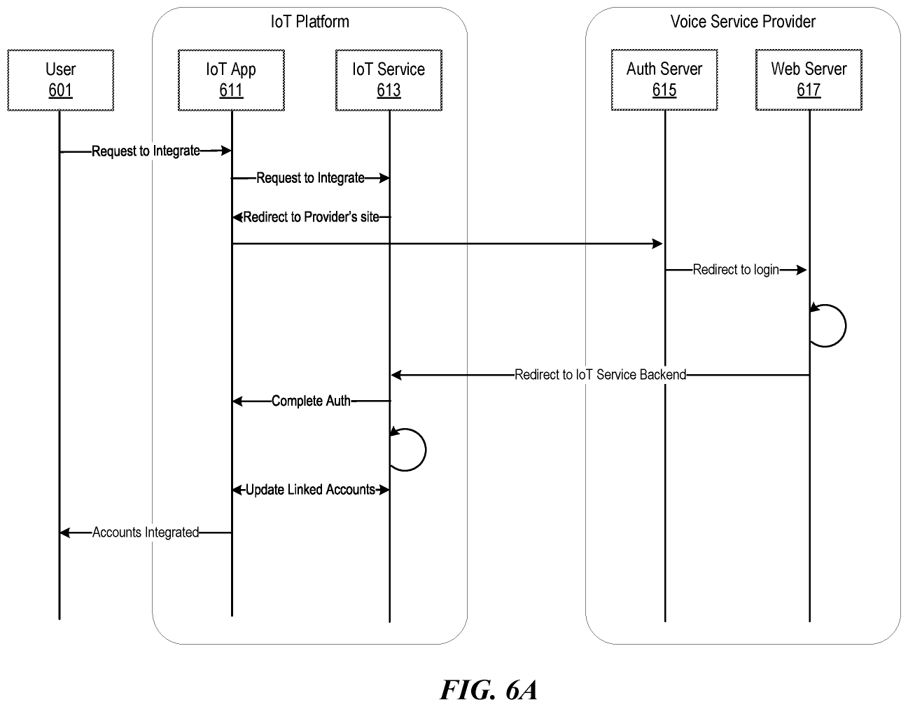

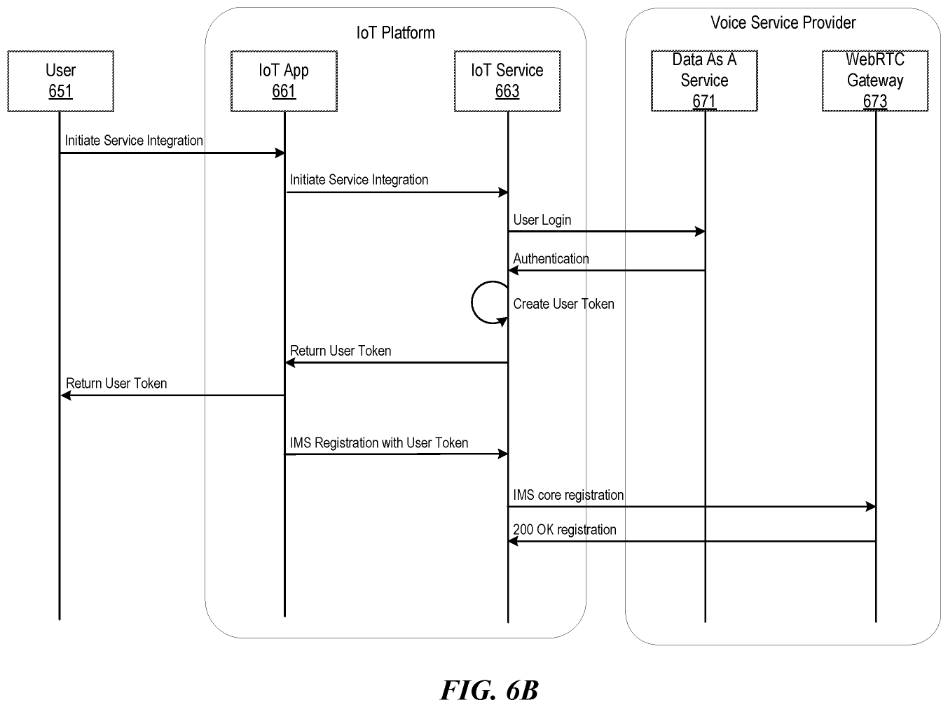

FIG. 6A is a sequence diagram illustrating an example flow of an account integration procedure in accordance with one or more embodiments of the present technology. User 601 initiates a request to integrate the services via the IoT application 611. The request is forwarded to IoT service 613. The IoT service 613 then redirects user 601, via the IoT application 611, to the call service provider's site to carry out proper user authentication and authorization steps. The authorization server 615 of the call service provider, upon receiving the redirection from the IoT service 613, directs the user 601 to a login page that is hosted by the web server 617. After user 601 enters the credential information, the call service provider authenticates the user and redirects the request to IoT service 613 to complete authorization. The IoT service 613 then updates the linked accounts and sends a confirmation to user 601 confirming that the accounts have been integrated.

FIG. 6B is another sequence diagram illustrating an example flow of an account integration procedure in accordance with one or more embodiments of the present technology. In the example, the second communication interface is implemented as Data as a Service 671 (DaaS). For example, DaaS can include a client component (e.g., a mobile application plugin) and a server component (e.g., one or more network servers in communication with the application plugin). User 651 initiates a request to integrate the services via the IoT application 661. The request is forwarded to the IoT service 663. The IoT service 663 then redirects the request to the call service provider's site to carry out proper user authentication and authorization steps. In this example, the user credentials can be entered via a user login page hosted by the call service provider. Upon successful user authentication, a user token can be created (e.g., by the DaaS or by the IoT service) and stored by the IoT service 663. The IoT service 663 returns the user token to the IoT application 661 so that the IoT application 661 can send a confirmation back to user 651 using the user token. The IoT platform then proceeds to Internet Protocol Multimedia Subsystem (IMS) registration with the call service provider using the user token. In some embodiments, the IoT service 663 can transmit an IMS core registration message to the real-time or near real-time communication interface (e.g., WebRTC gateway 673) to complete the registration process.

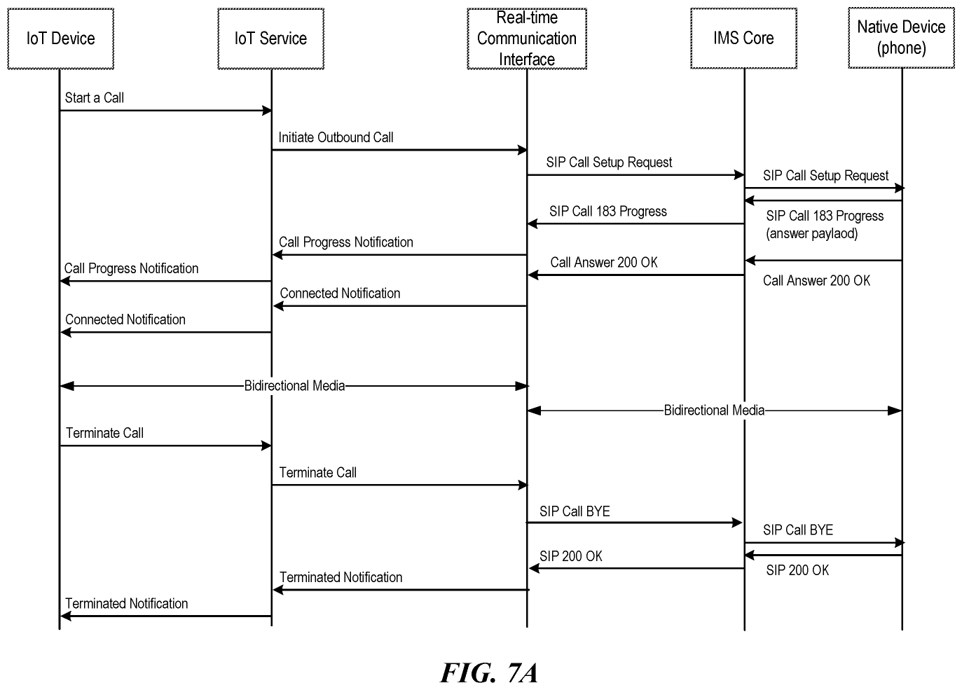

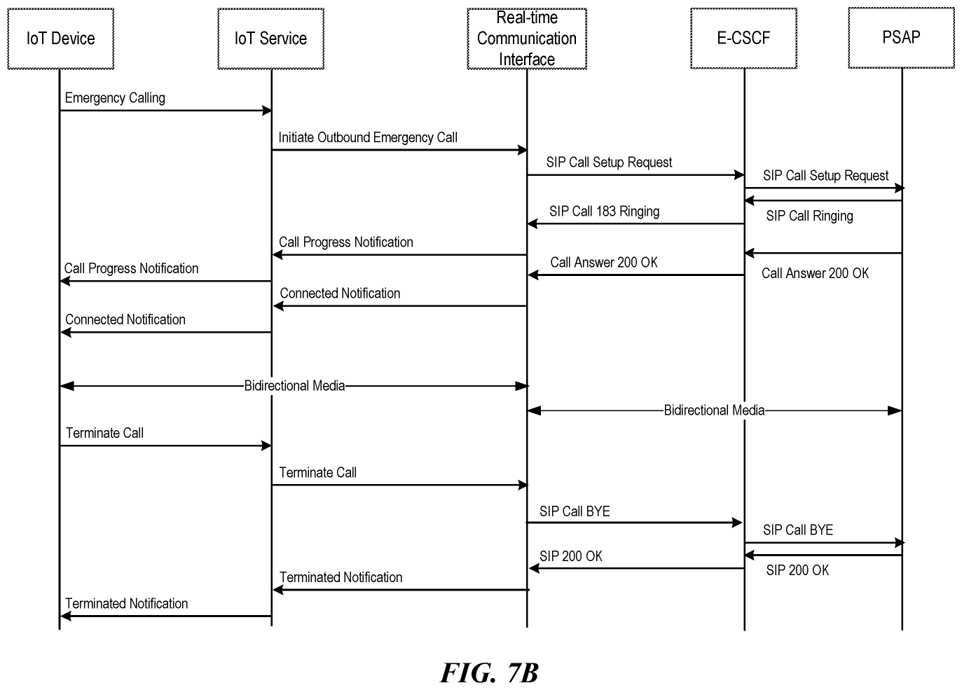

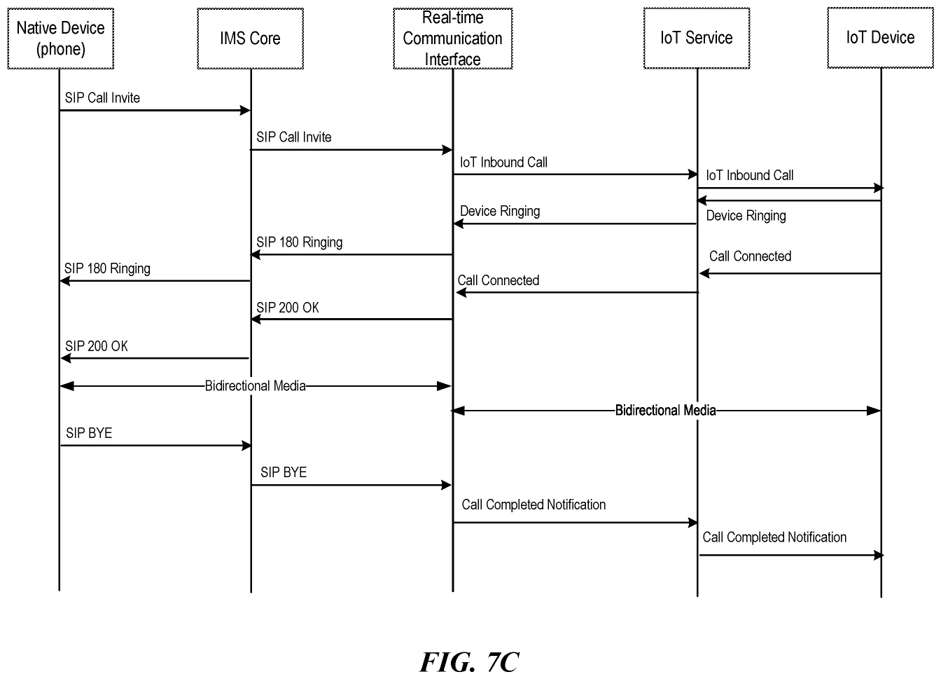

FIG. 7A illustrates an example sequence flow of initiating an outbound call from an IoT device in accordance with one or more embodiments of the present technology. The user starts a call on the IoT device (e.g., Alexa) by saying “Alexa, call Alice.” The IoT device communicates with its backend cloud service to initiate an outbound call. The real-time or near real-time communication interface (e.g., WebRTC) is in communication with the IoT service to convert the outbound call initiation request to a Session Initiation Protocol (SIP) call setup request to the IMS core of the call service provider. The real-time communication or near real-time interface also relays the SIP confirmations from the IMS core (e.g., call 183 progress, call answer 200 OK) to the IoT service (e.g., as call progress notification, call connected notification). Once the SIP session is established, the IoT device and the native device (phone) can make voice calls (e.g., exchanging bidirectional media) via the real-time or near real-time communication interface. When the user of the IoT device decides to end the call, the IoT device can send a request to terminate the call. The request is transmitted to the IMS core via the real-time or near real-time communication interface to terminate the call, and the IoT device will receive a termination notification from the IMS core via the real-time or near real-time communication interface.

FIG. 7B illustrates an example sequence flow of an outbound emergency call from an IoT device in accordance with one or more embodiments of the present technology. The user starts an emergency call on the IoT device (e.g., Alexa) by saying “Alexa, call 911.” The IoT device communicates with its backend cloud service to initiate an outbound emergency call. The real-time or near real-time communication interface (e.g., WebRTC) is in communication with the IoT service to convert the call initiation request to a Session Initiation Protocol (SIP) call setup request to the Emergency Call Session Control Function (E-CSCF) provided by the call service provider. The real-time or near real-time communication interface also relays the SIP confirmations from the IMS core (e.g., call 183 ringing, call answer 200 OK) to the IoT service (e.g., as call progress notification, call connected notification). Once the SIP session is established, the IoT device and the public safety answering point (PSAP) can communicate about the emergency (e.g., exchanging bidirectional media) via the real-time communication interface. When the user of the IoT device decides to end the call, the IoT device can send a request to terminate the call. The request is transmitted to the E-CSCF via the real-time or near real-time communication interface to terminate the call, and the IoT device will receive a termination notification from the IMS core via the real-time or near real-time communication interface.

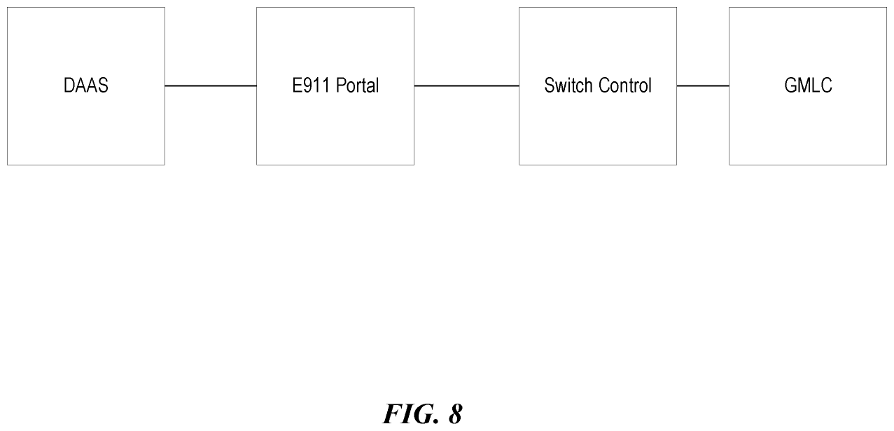

Because the IoT service communicates with the call service provider via the real-time or near real-time communication interface, the IoT platform does not need to implement any specific changes to support emergency calls. The real-time or near real-time communication interface distinguishes between regular calls and emergency calls and routes the calls to appropriate destinations (e.g., IMS core versus E-CSCF). Furthermore, the cloud service interface can be configured to manage/update emergency call information. FIG. 8 illustrates an example emergency call configuration in the call service provider's network in accordance with one or more embodiments of the present technology. In this example, the address/routing information for handling emergency calls can be updated on the Gateway Mobile Location Center (GMLC) via a portal (e.g., E911 portal) by the DaaS. The GMLC is a node configured for location-based services. With GMLC, the home network operator can get geographical coordinates and other useful details that are particularly important for handling emergencies. Given the integration framework shown in FIG. 3, emergency calling service can be seamlessly provided to IoT users without any additional configuration or deployment complexity.

FIG. 7C illustrates an example sequence flow of an inbound call from an IoT device in accordance with one or more embodiments of the present technology. In this example, a native device (e.g., Bob's phone) starts a call to an IoT system of the user (e.g., in-car voice system). The native device transmits a SIP call invite message to the IMS core. The IMS core then forwards the invite as an IoT inbound call to the IoT service via the real-time or near-real-time communication interface. Once the call session is established, the native device and the IoT device can communicate (e.g., exchanging bidirectional media) via the real-time or near-real-time communication interface. When the native device decides to end the call, it sends a request to the IMS core to terminate the call. The request is transmitted to the IoT service via the real-time or near real-time communication interface, and the IoT device will receive a call completed notification.

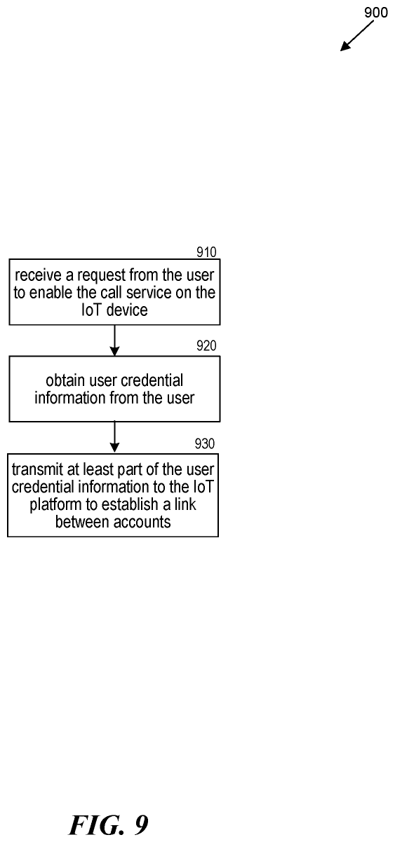

FIG. 9 is a flowchart representation of a method for enabling a call service on an IoT device of a user in accordance with one or more embodiments of the present technology. The IoT device is part of an IoT platform that includes at least the IoT device and an IoT service. The method 900 includes, at operation 910, receiving, by a mobile application that is in communication with an IoT service and a call service core network, a request from the user to enable the call service on the IoT device. The method 900 includes, at operation 920, obtaining, by the mobile application, user credential information from the user. The method 900 includes, at operation 930, transmitting, by the mobile application upon authentication of the user credential information by the call service core network, at least part of the user credential information to the IoT platform to establish a link between an IoT service account of the user and a call service account of the user.

In some embodiments, the method includes presenting, by the mobile application, a login page of the call service account of the user associated with the call service core network to obtain the user credential information. In some embodiments, the method includes enabling the call service on the IoT device by facilitating, using a communication interface associated with the mobile application, the exchange of one or more call signaling messages between the IoT device and the call service core network. In some embodiments, the IoT device comprises a voice-enabled device. In some embodiments, at least part of the user credential information is organized as a user token that is stored by the IoT service for subsequent calling.

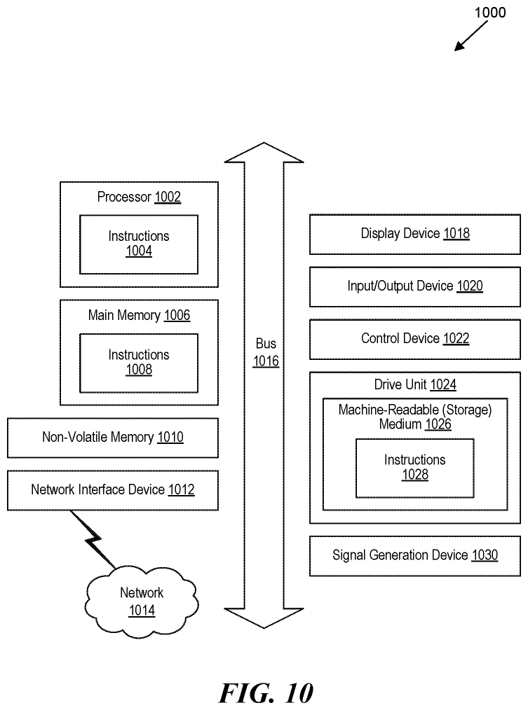

FIG. 10 is a block diagram that illustrates an example of a computer system 1000 in which at least some operations described herein can be implemented. As shown, the computer system 1000 can include one or more processors 1002, main memory 1006, non-volatile memory 1010, a network interface device 1012, a video display device 1018, an input/output device 1020, a control device 1022 (e.g., keyboard and pointing device), a drive unit 1024 that includes a machine-readable (storage) medium 1026, and a signal generation device 1030 that are communicatively connected to a bus 1016. The bus 1016 represents one or more physical buses and/or point-to-point connections that are connected by appropriate bridges, adapters, or controllers. Various common components (e.g., cache memory) are omitted from FIG. 10 for brevity. Instead, the computer system 1000 is intended to illustrate a hardware device on which components illustrated or described relative to the examples of the figures and any other components described in this specification can be implemented.

The computer system 1000 can take any suitable physical form. For example, the computing system 1000 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 1000. In some implementations, the computer system 1000 can be an embedded computer system, a system-on-chip (SOC), a single-board computer system (SBC), or a distributed system such as a mesh of computer systems, or it can include one or more cloud components in one or more networks. Where appropriate, one or more computer systems 1000 can perform operations in real-time, in near real-time, or in batch mode.

The network interface device 1012 enables the computing system 1000 to mediate data in a network 1014 with an entity that is external to the computing system 1000 through any communication protocol supported by the computing system 1000 and the external entity. Examples of the network interface device 1012 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 1006, non-volatile memory 1010, machine-readable medium 1026) can be local, remote, or distributed. Although shown as a single medium, the machine-readable medium 1026 can include multiple media (e.g., a centralized/distributed database and/or associated caches and servers) that store one or more sets of instructions 1028. The machine-readable medium 1026 can include any medium that is capable of storing, encoding, or carrying a set of instructions for execution by the computing system 1000. The machine-readable medium 1026 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 1010, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 1004, 1008, 1028) set at various times in various memory and storage devices in computing device(s). When read and executed by the processor 1002, the instruction(s) cause the computing system 1000 to perform operations to execute elements involving the various aspects of the disclosure.

### REMARKS

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

1. A system configured to integrate a call service to an Internet-of-Things (IoT) device of a user, wherein the IoT device is part of an IoT platform that includes at least the IoT device and an IoT service, the system comprising:
a call service network in a core network;
a gateway server in communication with the IoT device and the call service network, the gateway server configured to facilitate an exchange of one or more call signaling messages between the IoT device and the call service network; and
a communication plugin, deployed on a mobile device of the user, that is in communication with the IoT service and the call service network, the communication plugin configured to direct a service integration request from the user to the call service network to enable an integration of an IoT service account of the user and a call service account of the user.

2. The system of claim 1, wherein the gateway server is configured to:
receive a call request initiated from the IoT device, and
transmit a Session Initiation Protocol (SIP) setup request to the call service network in response to the call request.

3. The system of claim 1, wherein the gateway server is configured to:
receive a Session Initiation Protocol (SIP) invite request initiated from a voice call device via the call service network, and
transmit a call request to the IoT device in response to the SIP invite request.

4. The system of claim 1, wherein the gateway server comprises a real-time or near real-time communication interface.

5. The system of claim 1, wherein the gateway server comprises a Web Real-Time Communication (RTC) gateway.

6. The system of claim 1, wherein the communication plugin is configured to:
redirect the user to a login page associated with the call service network to enable the user to enter user credential information; and
transmit, upon successful authentication of the user credential information by the calls service network, at least part of the user credential information to the IoT service.

7. The system of claim 1, wherein the call service network comprises an Internet Protocol Multimedia Subsystem (IMS).

8. The system of claim 1, wherein the call service network comprises an emergency call session control function (E-CSCF).

9. A method for enabling a call service on an Internet-of-Things (IoT) device of a user, wherein the IoT device is part of an IoT platform that includes at least the IoT device and an IoT service, the method comprising:
receiving, by a mobile application that is in communication with an IoT service and a call service core network, a request from the user to enable the call service on the IoT device;
obtaining, by the mobile application, user credential information from the user;
transmitting, by the mobile application upon authentication of the user credential information by the call service core network, at least part of the user credential information to the IoT platform to establish a link between an IoT service account of the user and a call service account of the user.

10. The method of claim 9, comprising:
presenting, by the mobile application, a login page of the call service account of the user associated with the call service core network to obtain the user credential information.

11. The method of claim 9, comprising:
enabling the call service on the IoT device by facilitating, using a communication interface associated with the mobile application, an exchange of one or more call signaling messages between the IoT device and the call service core network.

12. The method of claim 9, wherein the IoT device comprises a voice-enabled device.

13. The method of claim 9, wherein the at least part of the user credential information is organized as a user token that is stored by the IoT service for subsequent calling.

14. A framework configured to integrate a call service to an Internet-of-Things (IoT) device of a user, comprising:
a first communication interface in communication with the IoT device and a call service network; and
a second communication interface in communication with an IoT service corresponding to the IoT device and the call service network, the second communication interface configured to direct a service integration request from the user to the call service network to enable an integration of an IoT service account of the user and a call service account of the user.

15. The framework of claim 14, wherein the first communication interface comprises a real-time or near real-time communication interface.

16. The framework of claim 14, wherein the first communication interface comprises a Web Real-Time Communication (RTC) interface.

17. The framework of claim 14, wherein the second communication interface is implemented as a plugin component corresponding to the IoT service.

18. The framework of claim 14, wherein the second communication interface is deployed on a mobile device of the user.

19. The framework of claim 14, wherein the first communication interface is configured to provide emergency calling capability on the IoT device by communicating with an Emergency Call Session Control Function in the call service network.

20. The framework of claim 14, wherein the second communication interface is configured to update routing information for handling emergency calls via a portal, wherein the routing information is stored in a network node related to a location-based service.
